(19) United States
(12) Patent Application Publication
(10) Pub. No.: US 2024/0080859 A1
(43) Pub. Date: Mar. 7, 2024

(54) PHYSICAL DOWNLINK CONTROL CHANNEL MONITORING WITH DISCONTINUOUS RECEPTION AND SEARCH SPACE SET GROUPS CONFIGURED

(71) Applicant: Telefonaktiebolaget LM Ericsson (publ), Stockholm (SE)

(72) Inventors: Ilmiawan SHUBHI, Malmö (SE); Ajit NIMBALKER, Dublin, CA (US); Ravikiran NORY, San José, CA (US); Sina MALEKI, Malmö (SE)

(21) Appl. No.: 18/272,682

(22) PCT Filed: Jan. 18, 2022
(86) PCT No.: PCT/EP2022/050936

§ 371 Date: Jul. 17, 2023

Related U.S. Application Data
(60) Provisional application No. 63/138,604, filed on Jan. 18, 2021.

(51) Int. Cl. H04W 72/232; H04L 5/00; H04W 76/28

(52) U.S. Cl. CPC H04W 72/232; H04L 5/0096; H04W 76/28

(57) ABSTRACT

A method is provided that is performed by a communication device for search space set group switching when discontinuous reception and at least two search space set groups are configured for at least one serving cell of a communication network for the communication device. The method includes monitoring a PDCCH of the at least one serving cell according to a first of the at least two search space set groups. The method further includes receiving an indication to switch to a second of the at least two search space set groups based on at least one condition related to at least one discontinuous reception state of the communication device. The method further includes switching to the second of the at least two search space set groups based on the at least one condition.

### TECHNICAL FIELD

The present disclosure relates generally to methods for search space set group switching when discontinuous reception and at least two search space set groups are configured for at least one serving cell of a communication network for a communication device, and related methods and apparatuses

### BACKGROUND

Physical downlink control channel (PDCCH) monitoring in active time can be one of the most power-consuming activities in a user equipment (UE) in cellular systems such as Fifth Generation (5G) New Radio (NR) and Long Term Evolution (LTE). Monitoring for PDCCH in the absence of data may be the dominant source of energy consumption in enhanced mobile broadband (eMBB) in typical scenarios. Considering this, techniques that can reduce unnecessary PDCCH monitoring are beneficial, e.g., allowing a UE to go to sleep (or omit PDCCH monitoring) when no data is scheduled and to wake-up (or monitor PDCCH) only when required.

During data transmission (e.g., a gNode B (gNB) has data in the buffer to be transmitted to the UE), it may be desirable that the UE monitors PDCCH in every slot (e.g., every 0.5 ms in a cell with 30 kHz subcarrier spacing) so that the UE is always ready for data reception/transmission and, thus, minimize packet transmission delay. This, however, may not be beneficial from the UE power consumption perspective.

### SUMMARY

Unnecessary PDCCH monitoring during running of a discontinuous reception (DRX) inactivity timer (IAT) can consume significant UE power. In Rel. 16, the 3rd Generation Partnership Project (3GPP) introduced a search space (SS) set group switching feature (SS-switching procedure) which is applicable for NR unlicensed (NR-U). The relation to the basic power-saving procedures in NR, e.g., DRX, however, is not yet provided; and some approaches may cause delay and/or inconsistency on which SS-set group a UE should apply. Various embodiments of the present disclosure provide a method of SS-switching procedures when the UE is also configured with a DRX feature. Potential advantages that may be provided by one or more embodiments of the present disclosure may include UE power consumption improvement, additional delay caused by the implementation of SS-switching when a UE is also configured with the DRX feature may be minimized, and/or inconsistency on which SS-set group the UE should apply may be omitted.

According to some embodiments of the present disclosure, a method performed by a communication device for search space set group switching when discontinuous reception and at least two search space set groups are configured for at least one serving cell of a communication network for the communication device is provided. The method includes monitoring a physical downlink control channel, PDCCH, of the at least one serving cell according to a first of the at least two search space set groups. The method further includes receiving an indication to switch to a second of the at least two search space set groups based on at least one condition related to at least one discontinuous reception state of the communication device. The method further includes switching to the second of the at least two search space set groups based on the at least one condition.

In some embodiments, the communication device is configured with search space set group switching, and the method includes further operations including receiving, from the network node, a value of a switching timer configured for the communication device for the search space set group switching.

In some embodiments, the method further includes determining a validity of a switching timer with respect to the at least one discontinuous reception state.

In some embodiments, the method further includes receiving, from the network node, a configuration for discontinuous reception adaptation.

According to other embodiments of the present disclosure, a method performed by a network node for search-search space set group switching when discontinuous reception and at least two search space set groups are configured for at least one serving cell of a communication network for a communication device is provided. The method includes sending an indication to the communication device to switch to a second of the at least two search space set groups based on at least one condition related to at least one discontinuous reception state of the communication device.

In some embodiments, the method further includes sending, to the communication device, a value of a switching timer configured for the communication device for a search space set group switching.

In some embodiments, the method further includes sending, to the communication device, a configuration for discontinuous reception adaptation.

Corresponding embodiments of inventive concepts for a communication device, a network node, computer program products, and computer programs are also provided.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts. In the drawings:

FIG. 1 is a schematic illustrating a communication network including a network node and a communication device in accordance with various embodiments of the present disclosure;

FIG. 2 is a schematic illustrating a procedure for explicit switching using downlink control information (DCI) format 2_0;

FIG. 3 is a schematic diagram illustrating a procedure for implicit search space set switching;

FIG. 4 is a schematic diagram illustrating an SS-switching implementation in accordance with some embodiments of the present disclosure;

FIG. 5 is a schematic diagram illustrating an SS-switching implementation in accordance with some embodiments of the present disclosure;

FIG. 6 is a schematic diagram illustrating an SS-switching implementation in accordance with some embodiments of the present disclosure;

FIGS. 7-8 are flowcharts of operations performed by a communication device, in accordance with some embodiments of the present disclosure;

FIGS. 9-10 are flowcharts of operations performed by a network node, in accordance with some embodiments of the present disclosure;

FIG. 11 is a block diagram of a wireless network in accordance with some embodiments of the present disclosure;

FIG. 12 is a block diagram of a user equipment or other terminal (also referred to herein as a communication device) in accordance with some embodiments of the present disclosure;

FIG. 13 is a block diagram of a virtualization environment in accordance with some embodiments of the present disclosure;

FIG. 14 is a block diagram of a telecommunication network connected via an intermediate network to a host computer in accordance with some embodiments of the present disclosure;

FIG. 15 is a block diagram of a host computer communicating via a base station with a user equipment user equipment or other terminal over a partially wireless connection in accordance with some embodiments of the present disclosure;

FIG. 16 is a block diagram of methods implemented in a communication system including a host computer, a base station and a user equipment user equipment or other terminal in accordance with some embodiments of the present disclosure;

FIG. 17 is a block diagram of methods implemented in a communication system including a host computer, a base station and a user equipment user equipment or other terminal in accordance with some embodiments of the present disclosure;

FIG. 18 is a block diagram of methods implemented in a communication system including a host computer, a base station and a user equipment user equipment or other terminal in accordance with some embodiments of the present disclosure; and

FIG. 19 is a block diagram of methods implemented in a communication system including a host computer, a base station and a user equipment user equipment or other terminal in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter. The term “communication device” is used in a non-limiting manner and, as explained below, can refer to any type of radio communication terminal. The term “communication device” herein may be interchangeable replaced with the terms “user equipment” or “UE”.

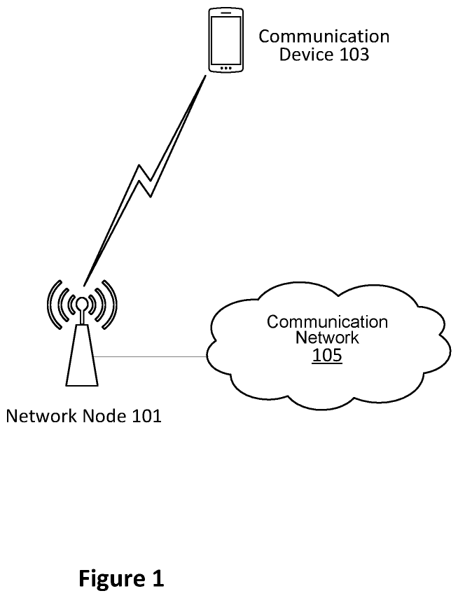

FIG. 1 is a schematic illustrating a communication network 105 including a network node 101 and a communication device 103 in accordance with various embodiments of the present disclosure.

The following explanation of potential problems and existing solutions is a present realization as part of the present disclosure and is not to be construed as previously known by others.

In typical eMBB traffic scenarios, unnecessary PDCCH monitoring during running of a DRX inactivity timer (IAT) can consume significant UE power. Thus, large energy savings may be expected from reducing PDCCH monitoring during the durations when the IAT is running.

In Rel. 16, 3GPP introduced a search space (SS) set group switching feature which is applicable for NR unlicensed (NR-U). In the present disclosure, this feature is referred to herein as “search space set group switching” or “SS-switching”.

While it may be possible to extend SS-switching to be used as a power-saving feature for typical NR implementation (e.g., enhanced mobile broadband, eMBB), SS-switching is mainly designed for the listen before talk (LBT) procedures in NR-U. The relation to the basic power-saving procedures in NR, e.g., DRX, therefore, is not yet given.

According to the current 3GPP specification (e.g., TS 38.213 v16.4.0), the SS-set group applied during DRX on-duration will depend only to the switching indication (either implicit, e.g., timer; or explicit, e.g., switching command from DCI). In one approach, to achieve UE power-saving, it may be most likely that SS-set group0 and SS-set group1 will be configured to have different periodicity. Unfortunately, using the SS-set group with sparser PDCCH monitoring occasions (MOs) during DRX on-duration may have a large effect in terms of additional delay, in particular when the DRX cycle is relatively long.

Additionally, there may be some inconsistency in terms of which SS-set group the UE should employ to monitor PDCCH during the DRX on-duration. This is due to that a switching timer depends only on when the UE receives the switching indication. The DRX on-duration, on the other hand, is a grid-based, i.e., the gap between the end of the IAT and the start of the on-duration may vary.

As a consequence of these potential problems, there is a need for a method providing procedures of SS-switching when the UE is also configured with a DRX feature.

Various embodiments of the present disclosure may provide solutions to these and other potential problems. In various embodiments of the present disclosure, methods are provided for implementation of SS-switching when DRX is configured. Embodiments include a determination of the applied SS-set group during DRX on-duration. Embodiments further include the relation between the timer in the SS-switching feature, e.g., a switching timer, and the timer in the DRX feature, e.g., the inactivity timer.

Operational advantages that may be provided by one or more embodiments of the present disclosure may include UE power consumption improvement; additional delay caused by the implementation of SS-switching when a UE is also configured with the DRX feature may be minimized; and/or the inconsistency on which SS-set group the UE should apply may be omitted.

The SS-switching mechanism described in 3GPP TS 38.213 v16.4.0 is as follows:

### Search Space Set Group Switching

A UE can be provided a group index for a respective Type3-PDCCH common search space (CSS) set or UE specific search space (USS) set by searchSpaceGroupldList for PDCCH monitoring on a serving cell. If the UE is not provided searchSpaceGroupldList for a search space set, the following procedures are not applicable for PDCCH monitoring according to the search space set.

If a UE is provided cellGroupsForSwitchList, indicating one or more groups of serving cells, the following procedures apply to all serving cells within each group; otherwise, the following procedures apply only to a serving cell for which the UE is provided searchSpaceGroupldList.

When a UE is provided searchSpaceGroupldList, the UE resets PDCCH monitoring according to search space sets with group index 0, if provided by searchSpaceGroupldList.

A UE can be provided by searchSpaceSwitchDelay a number of symbols P_{switch} where a minimum value of P_{switch} is provided in Table 10.4-1 for UE processing capability 1 and UE processing capability 2 and SCS configuration μ. UE processing capability 1 for subcarrier spacing (SCS) configuration μ applies unless the UE indicates support for UE processing capability 2.

TABLE 10.4-1
Minimum value of P_{switch}
[symbols]

| | Minimum P_{switch} | Minimum P_{switch} |
|---|---|---|
| | value for | value for |
| | UE processing | UE processing |
| | capability 1 | capability 2 |
| μ | [symbols] | [symbols] |
| 0 | 25 | 10 |
| 1 | 25 | 12 |
| 2 | 25 | 22 |

A UE can be provided, by searchSpaceSwitchTimer, a timer value for a serving cell that the UE is provided searchSpaceGroupldList or, if provided, for a set of serving cells provided by cellGroupsForSwitchList. The UE decrements the timer value by one after each slot based on a reference SCS configuration that is the smallest SCS configuration μ among all configured downlink (DL) bandwidth parts (BWPs) in the serving cell, or in the set of serving cells. The UE maintains the reference SCS configuration during the timer decrement procedure.

If a UE is provided by SearchSpaceSwitchTrigger a location of a search space set group switching flag field for a serving cell in a DCI format 2_0, as described in Clause 11.1.1;
if the UE detects a DCI format 2_0 and a value of the search space set group switching flag field in the DCI format 2_0 is 0, the UE starts monitoring PDCCH according to search space sets with group index 0, and stops monitoring PDCCH according to search space sets with group index 1, for the serving cell at a first slot that is at least P_{switch} symbols after the last symbol of the PDCCH with the DCI format 2_0
if the UE detects a DCI format 2_0 and a value of the search space set group switching flag field in the DCI format 2_0 is 1, the UE starts monitoring PDCCH according to search space sets with group index 1, and stops monitoring PDCCH according to search space sets with group index 0, for the serving cell at a first slot that is at least P_{switch} symbols after the last symbol of the PDCCH with the DCI format 2_0, and the UE sets the timer value to the value provided by searchSpaceSwitchTimer
if the UE monitors PDCCH for a serving cell according to search space sets with group index 1, the UE starts monitoring PDCCH for the serving cell according to search space sets with group index 0, and stops monitoring PDCCH according to search space sets with group index 1, for the serving cell at the beginning of the first slot that is at least P_{switch} symbols after a slot where the timer expires or after a last symbol of a remaining channel occupancy duration for the serving cell that is indicated by DCI format 2_0
   If a UE is not provided SearchSpaceSwitchTrigger for a serving cell,
if the UE detects a DCI format by monitoring PDCCH according to a search space set with group index 0, the UE starts monitoring PDCCH according to search space sets with group index 1, and stops monitoring PDCCH according to search space sets with group index 0, for the serving cell at a first slot that is at least P_{switch} symbols after the last symbol of the PDCCH with the DCI format, the UE sets the timer value to the value provided by searchSpaceSwitchTimer if the UE detects a DCI format by monitoring PDCCH in any search space set
if the UE monitors PDCCH for a serving cell according to search space sets with group index 1, the UE starts monitoring PDCCH for the serving cell according to search space sets with group index 0, and stops monitoring PDCCH according to search space sets with group index 1, for the serving cell at the beginning of the first slot that is at least P_{switch} symbols after a slot where the timer expires or, if the UE is provided a search space set to monitor PDCCH for detecting a DCI format 2_0, after a last symbol of a remaining channel occupancy duration for the serving cell that is indicated by DCI format 2_0

A UE determines a slot and a symbol in the slot to start or stop PDCCH monitoring according to search space sets for a serving cell that the UE is provided searchSpaceGroupldList or, if cellGroupsForSwitchList is provided, for a set of serving cells, based on the smallest SCS configuration μ among all configured DL BWPs in the serving cell or in the set of serving cells and, if any, in the serving cell where the UE receives a PDCCH and detects a corresponding DCI format 2_0 triggering the start or stop of PDCCH monitoring according to search space sets.

In short, SS-set switching can be described as follows:

Two groups of search space sets can be configured in Rel-16. If configured (e.g., through the radio resource control (RRC) parameters searchSpaceGroupIdList-r16 and searchSpaceSwitchingGroup-r16.), then the UE can be switched between these two groups using either explicit or implicit mechanisms. Some search spaces may not appear in the search space sets. Such search spaces can be monitored always and monitoring of such search spaces is not impacted by the search space set switching mechanism.

Explicit SS switching will now be discussed.

A UE can be switched between the two search space set groups through detection of DCI format 2_0. This is can be done by configuring the UE with the RRC parameter searchSpaceSwitchTrigger-r16 which provides a location for the search space switching field (for a serving cell) in the DCI format 2_0. The search-space-set-switching field is one bit in size, where a bit value of zero indicates one group and a value of one indicates the second group. Herein, these two groups are referred to as group0 and group1, where the search-space-set-switching field takes the values zero and one, respectively.

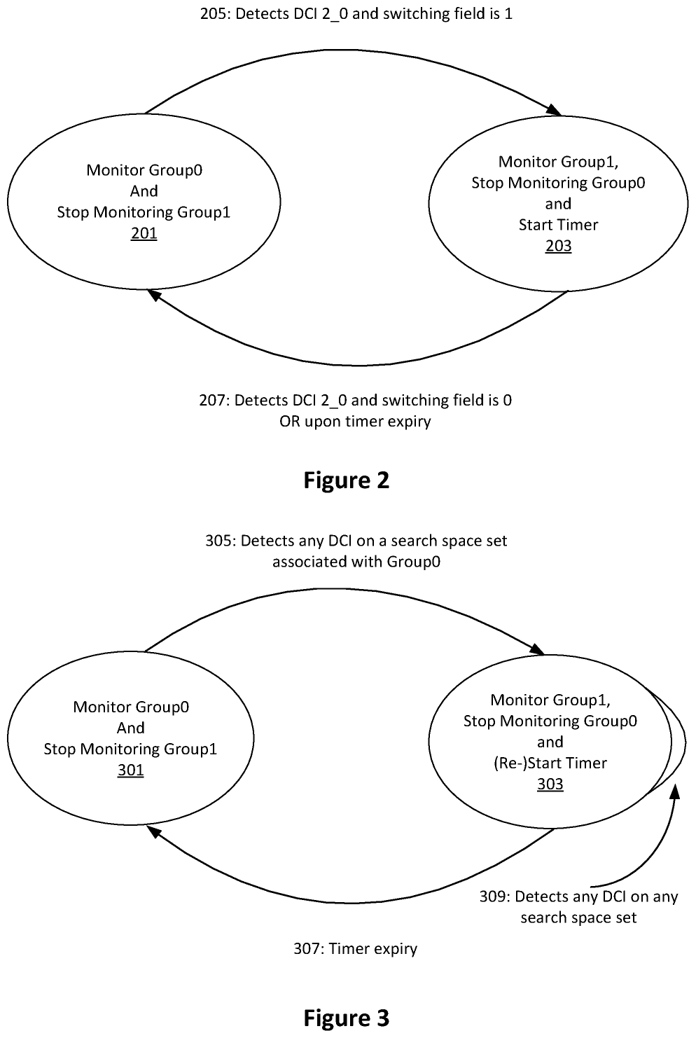

FIG. 2 is a schematic illustrating a procedure for explicit switching using DCI format 2_0. Referring to FIG. 2, a procedure for explicit switching using DCI format 2_0 is as follows:
If the UE is not monitoring PDCCH on search space sets corresponding to group0 and the UE detects DCI format 2_0, then the UE switches to search space sets of group0 provided the search-space-set-switching field indicates a value of zero (operation 207), and stops monitoring PDCCH on search space sets associated with group1 (operation 201).
If the UE is not monitoring PDCCH on search space sets corresponding to group1 and the UE detects DCI format 2_0, then the UE switches to search space sets of group1 provided the search-space-set-switching field indicates a value of one (operation 205). The UE also stops monitoring PDCCH on search space sets corresponding to group0 and starts a timer with a duration provided by the searchSpaceSwitchingTimer (operation 201).
If the UE is monitoring PDCCH on search space sets corresponding to group1, then the UE switches (or starts monitoring on) to search space sets of group0 and stops monitoring on group1 at either expiration of the searchSpaceSwitchingTimer or at the last slot of a remaining channel occupancy duration for the serving cell that is indicated by DCI format 2_0 (operation 207).

Implicit SS switching will now be discussed.

Implicit switching happens when the UE is not configured with the RRC searchSpaceSwitchTrigger-r16 parameter. FIG. 3 is a schematic diagram illustrating a procedure for implicit search space set switching. Referring to FIG. 3, the procedure is as follows:
if the UE detects a DCI format in group0 (operation 301), the UE switches to monitoring PDCCH according to SS set in group1 (operation 305) on the serving cell at a first slot that is at least P symbols after the slot in the active DL BWP. The UE sets the timer value to the value provided by searchSpaceSwitchingTimer-r16 if the UE detects a DCI format by monitoring PDCCH in any search space set. This applies to every subsequent detection of a DCI in any search space; if the timer is running the UE restarts the timer.
if the UE monitors SS sets in group1 (operation 303), the UE switches to monitoring SS sets in group0 at the beginning of the first slot that is at least P symbols after a slot where the timer expires (operation 307) or, if the UE is provided a search space set for DCI format 2_0, after a last slot of a remaining channel occupancy duration for the serving cell that is indicated by DCI format 2_0 (operation 309).

The second bullet above implies that even in the implicit case, it is still possible to enforce a set switch from group1 to group 0 given that the UE has been configured with a search space configuration for DCI format 2_0. However, note that DCI format 2_0 is configured in the common search space and potentially affects group transitions for all UEs with the same slot formation indication-radio network temporary identifier (SFI-RNTI) decoding the DCI; i.e., the set switching is not controlled on a UE-basis.

In some approaches, it is noted that a UE can be configured with up to 10 search spaces.

In some approaches, cell groups are defined for SS switching such that if SS switching is triggered for one cell in the group of cell, it also triggers SS switching for all cells in the corresponding group. In Rel-16, four cell groups are specified.

In some approaches, the search space set triggering indication can also be provided in scheduling DCI such as DCI 1-1 that schedule downlink data (e.g., physical downlink shared channel (PDSCH)) or DCI 0-1 that can schedule uplink data (e.g. physical uplink shared channel (PUSCH)).

In various embodiments of the present disclosure, the UE 103 is configured with one or more DRX configurations. As used in the present disclosure, references to DRX refer to the connected mode DRX, or C-DRX. A C-DRX configuration may at least include a configuration regarding an ON duration timer, an inactivity timer (IAT), and a DRX cycle. The C-DRX configuration may be further configured as a long or short DRX. In case the UE 103 is configured with short DRX alone or together with long DRX, it may also be configured with a short DRX cycle and a short DRX timer. Furthermore, the UE 103 may be configured with one or more DRX configurations, e.g., the UE 103 may be configured with a secondary DRX where the secondary DRX configuration can be different in terms its ON duration timer (e.g., smaller than the first DRX On duration timer), and its IAT (e.g., smaller than the first DRX IAT). In example embodiments of the present disclosure, when a DRX configuration is not explicitly mentioned, DRX refers to the first DRX configuration.

In various embodiments of the present disclosure, UE 103 is also configured with a SS-switching feature. UE 103 is configured with one or more search space set groups for one or more cells, or group of cells or bandwidth parts (BWPs). For potential UE power-saving, the SS-set group0 and the SS-set group1 configured for the UE can be different at least in terms of their configured periodicities. Note, however, that the methods of various embodiments of the present disclosure are not limited to this arrangement and are applicable for other arrangements, e.g., network node 101 can configure the SS-set group0 and the SS-set group1 to have the same periodicities but different in other parameters, e.g., offset, duration, aggregation level (AL), associated corset, monitoring symbols within the slot, SS type, associated DCI formats, etc.

In various embodiments, the method defines the relation between the SS-switching feature and the DRX feature as described further herein. While example embodiments herein focus on a case where the UE is configured with two SS groups by the network through higher layer signalling, e.g., RRC signalling, the present disclosure is not so limited and includes, e.g., example embodiments where a communication device (e.g., UE 103) is configured with more than two groups.

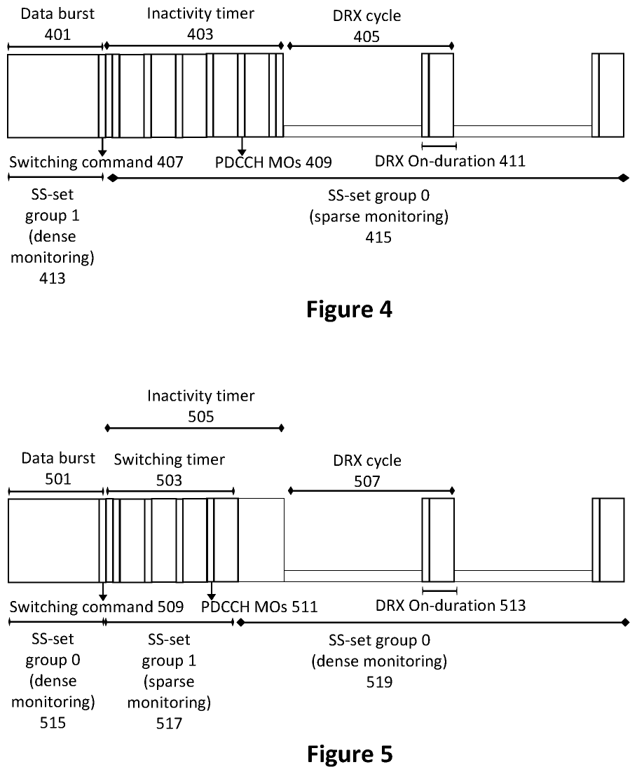

In an example embodiment that may achieve power-saving, the UE 103 can be configured with two search space set groups (a first search space set group e.g., the SS-set group0 with sparse PDCCH MOs and a second search space set group e.g., SS-set group1 with dense PDCCH MOs). The UE 103 monitors PDCCH according to the second search space set group, and determines that it should monitor PDCCH according to the first search space set group based on receiving via a first DCI a command to switch to the first search space set group or upon expiry of a switching timer. As the first search space set group is the search space set group used upon expiry of a switching timer, the UE 103 will continue to apply this search space set group (including during the DRX on-duration) as long as it does not receive via a second DCI a command to go back to the second search space set group. An example of this example embodiment can be seen in FIG. 4. FIG. 4 is a schematic illustrating an SS-switching implementation with SS-set group 0 (415) and SS-set group 1 (413) set with the sparse PDCCH

MOs and dense PDCCH MOs, respectively. This set-up may potentially increase the delay significantly, when the DRX cycle 405 is quite long.

Thus, in some embodiments of the present disclosure, a communication device (e.g., UE 103) is configured with DRX in connected mode. UE 103 can be configured with two search space set groups (a first search space set group e.g. the SS-set group0 with sparse PDCCH MOs and a second search space set group, e.g. SS-set group1 with dense PDCCH MOs) for at least one serving cell. The serving cell can be a primary cell. UE 103 monitors PDCCH of the serving cell according to the second search space set group. UE 103 determines that it should monitor PDCCH according to the first search space set group based on receiving via a first DCI a command/indication to switch to the first search space set group or upon expiry of a first switching timer. UE 103 can be configured to switch to a pre-determined search space set group based on one or more additional conditions related to the timers associated with the DRX functionality. In an example embodiment, the UE 103 can be configured to switch a pre-determined search space set group (e.g., SSSG1) when a DRX Inactivity timer has expired.

In an example embodiment, the pre-determined search space set group can be pre-configured, e.g., in standardization documentation. Pre-configuration based on a standardization document is also referred to herein as “predefined”. In an example embodiment, once the inactivity timer expired, the UE 103 uses SSSG1 for PDCCH monitoring.

In another example embodiment, the pre-determined search space set group can be explicitly configured by higher layers, e.g., at the RRC configuration. For example, a new RRC parameter, e.g., ss-set-groupOfOnDuration is introduced to determine which SS-set group the UE 103 needs to use during DRX on-duration. The possible value can be an integer value, e.g., 0 or 1; or an enumerated value, e.g., ss-setGroup0 or ss-setGroup1. In determining which SS-set group sis used during on-duration, network node 101 may consider the network node load, quality of service (QoS) of the UE application, traffic type, etc. The network node 101 can also consider other configured parameters, e.g., the DRX-cycle length.

In another example embodiment, the pre-determined search space set group can be both explicitly configured by higher layers and pre-configured. E.g., if the UE 103 behavior in this case is pre-configured, e.g., a default behavior, but the UE 103 additionally is configured with a specific behavior through higher layer signaling, then the latter take precedence and the UE 103 can ignore the pre-configured index, or vice versa. In another example embodiment, the UE 103 can be configured to switch a pre-determined search space set group (e.g., SSSG1) when DRX On duration timer starts. The pre-determined search space set group index can be explicitly configured by higher layers, or pre-configured, or a combination of both, e.g., the pre-determined index may be pre-configured but if the associated parameter is also configured with higher layer signaling, then the latter take precedence. In another example, the UE 103 can be configured to switch to a pre-determined search space set group (e.g., SSSG1) when the UE 103 active time ends. In one example embodiment, the UE 103 active time means when the UE 103 is running the ON duration timer or the inactivity timer. The pre-determined search space set group index can be explicitly configured by higher layers, or pre-configured. This allows a UE 103 to start data reception at the beginning of DRX ON duration at the next DRX cycle without the delays to switch the SSSGs.

In some embodiments, the UE 103 behavior is as described in the above example embodiment, in addition to the DRX state of the UE 103, it also depends on the value of a specific parameter which is configured for the specific DRX state. Example embodiments of DRX state include ON duration timer, inactivity timer, long DRX cycle, short DRX cycle, short DRX timer, etc. In an example embodiment, the UE 103 is configured with a first DRX state with a first value (e.g., an inactivity timer of 100 ms), and in this case either the UE 103 is configured through higher layer signaling to consider the second SS group as the default SS during the on-duration timer, or based on pre-configuration and on a condition on the value of inactivity timer to be higher than a first threshold, then the UE 103 knows that the second SS group is the default one. Furthermore, the condition can also be signaled through higher layer signaling, e.g., the network node 101 provides the condition that if the inactivity timer is above ms, then the UE 103 should use the second SS group as the default one during on-duration. But if the network node 101 changes the DRX configuration and e.g., shorten inactivity timer to 4 ms, then the UE 103 considers the first SS group as the default one. As such, the UE 101 receives a first DRX configuration including a number of DRX states, e.g., a first on duration timer, a first inactivity timer and a first DRX cycle, and furthermore the UE 103 is configured with a condition (either through higher layer signaling or pre-configuration as in standardization documentations), based on which the UE 103 can decide which SS group is considered as the default one during each DRX state. E.g., the condition can be if the first On duration timer is larger than a second threshold, e.g., 10 ms, then the UE 103 considers the first SS group as the default one during ON duration timer, but if it is larger than the second threshold, then the second SS group is the default one. A potential advantage of this approach is that even if the network node 101 changes the DRX configuration, then the UE 103 is already configured with which SS group should be considered as the default one during each DRX state. The network node 101 can change the DRX configuration e.g., through RRC signaling or other types of signaling, e.g., medium access control (MAC) control element (CE) or L1 based signaling. E.g., if multiple DRX configurations are provided, and the network node 101 indicates through L1/L2 signaling to the UE 103 which of them is applicable at the moment, or that the network node 101 applies RRC reconfiguration to change the DRX configuration. The same procedure can also be used when the UE 103 is configured with more than two DRX configurations the same time, e.g., when the UE 103 in addition to a first DRX, it is also configured with a secondary DRX. As such, based on the value of each DRX state in each of the DRX configurations, the UE 103 knows which of the SS groups is considered as the default one in each of the DRX states of each DRX configuration.

In some embodiments, the determination of whether a pre-determined search space set group is used, or is not be used, by the UE 103 after one or more additional conditions related to the time associated with the DRX functionality is fulfilled can depend on a previous triggering command. In an example embodiment, if the previous switch from SS-set group1 to SS-set group0 is initiated by the implicit indication (e.g., end of switching timer), the UE 103 applies SS-set group1 during DRX on-duration; and if the switch SS-set group1 to SS-set group0 is initiated by the explicit indication (e.g., through DCI), the SS-set group0 is used by the UE 103 during DRX on-duration. While this is an example embodiment, the present disclosure is not limited to this example embodiment and, includes without limitation, other rules on which triggering commands lead to the usage of SS-set group0 or SS-set group1 during DRX on-duration.

In some embodiments, the determination of whether a pre-determined search space set group is used, or is not be used, by the UE 103 during DRX on-duration may also depend on the type of DRX cycle to which the on-duration belongs to. E.g., the UE 103 uses first configured search space set group (e.g. SS-set group0) during the short DRX cycle and uses a second configured search space set group (e.g. SS-set group1) during the long-DRX cycle. In an example embodiment, the UE 103 is configured by network node 101 through higher layer signaling, e.g., at the time of DRX configuration, or SS group configuration, which search space set group should be used during the short or long-DRX on-duration. Alternatively, this can be obtained by the UE 103 through pre-definition, e.g., the standardization documentation may note that a specific type of SS groups can be considered for short or long DRXs.

In another example embodiment that may achieve power saving, the UE can be configured with two search space set groups (a first search space set group e.g. the SS-set group0 with dense PDCCH MOs and a second search space set group e.g. SS-set group1 with sparse PDCCH MOs). The UE monitors according to the first search space set group and determines that it should monitor PDCCH according to the second search space set group based on receiving via a first DCI a command to switch to the second search space set group. The UE will continue to use the second search space set group until it receives a command to switch to the first search space set group via a second DCI or upon expiry of switching timer.

FIG. 5 is a schematic diagram illustrating example embodiment where a UE may need to use dense monitoring 519 even when an IAT 505 does not end yet. An issue in using this configuration is that in the current specification, the switching timer 503 is quite short, i.e., maximum 20 ms. For power-saving for an eMBB application, this value may not be enough as the IAT 505 might be longer than 20 ms. Thus, the UE 103 may switch back to dense monitoring 519 (i.e., SSSG0) even when the IAT 505 is still running.

In some embodiments, therefore, the maximum value of switching timer (e.g., 503) might depend on the use case, e.g., a per band maximum switching timer, e.g., for the use in the NR-U, the switching timer may have a maximum value of X ms (e.g., 20 ms) and for the use in NR-licensed, the switching timer may have a maximum value of Y ms (e.g., >20 ms). Additionally, in another example embodiment, the maximum switching timer may also be based on the DRX implementation. For example, if DRX is configured for the UE 103, the switching timer may have a maximum value X ms; while if DRX is not configured for the UE 103, the switching timer may have a maximum value of Y ms.

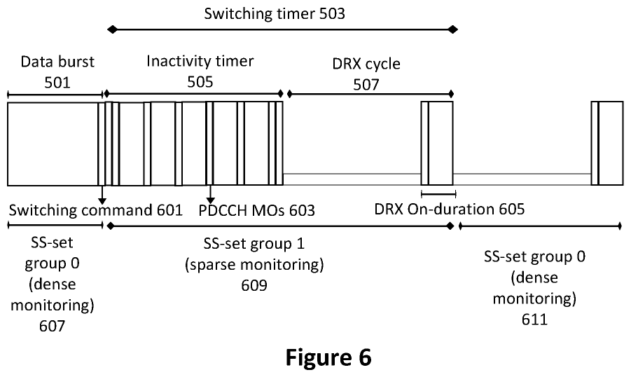

FIG. 6 is a schematic illustrating that for some occasions, however, the switching timer (e.g., 503) might be too large, causing the UE to remain using SS-set group1 609 (sparse monitoring) during one or more DRX on-duration 605.

To address this potential problem, in some embodiments of the present disclosure, the UE 103 assumes that the switching timer is valid only during the timer associated with DRX, e.g., the inactivity timer, on-duration timer. In an example embodiment, the end of the inactivity timer or on-duration timer will also cause the switching timer to end. In another example embodiment, the UE 103 assumes that the switching timer is only valid until the start of the first DRX on-duration. As such, the UE 103 receives a configuration of the switching timer, the UE 103 starts the switching timer during one of the DRX states, e.g., inactivity timer, and when the DRX state finishes, e.g., end of the inactivity timer, or when the UE 103 active time ends, then the UE 103 stops the switching timer. The condition can further distinguish between the short and long DRX, e.g., when the UE 103 enters the long DRX OFF duration, then the switching timer stops, but as far as short DRX cycle is running, the switching timer may still be running, or vice versa.

In some embodiments, the UE 103 is configured with two or more DRX configurations at the same time, e.g., in addition to the first DRX configuration, the UE 103 is also configured with a secondary DRX, where they are different at least in ON duration timer or inactivity timer. In an example embodiment, the UE 103 applies the same configured behavior with regard to which SS group to use as the default one in each of the DRX states, irrespective of the DRX configuration, i.e., the same configuration of default SS group as described in this invention applies to both. In another example embodiment, the network node 101 configures the UE 103 behavior in each of the DRX configurations separately, e.g., the UE 103 may apply the second SS group as the default one during the inactivity timer of the first DRX, but the first SS group as the default one in the inactivity timer of the secondary DRX, or vice versa. In another example embodiment, the UE 103 is configured with a different switching timer for the first DRX than the one of the secondary DRX.

In some embodiments, the UE 103 is configured in addition to a DRX configuration, with a DRX adaptation mechanism, e.g., the UE 103 is configured with a DCI format 2-6 which the UE 103 can/should monitor outside the active time. E.g., a DCI format 2-6 outside the active time can indicate to the UE 103 if it should monitor PDCCH during the next ON duration timer or not. A DCI format 2-6 may be associated with one or more SSs, e.g., one or more Type3-PDCCH CSS. In an example embodiment, if one or more SSs associated with the DCI format 2-6 exists in both of SS groups, the UE 102 monitors the DCI format 2-6 in the related SS, but if the DCI format 2-6 is only associated with one SS group, e.g., the second SS group, but at a time the first SS group is applicable, then the UE 103 does not have to monitor DCI format 2-6 and should wake up in the next ON duration timer and monitor PDCCH. Alternatively, the DCI format 2-6 outside the active time and its associated SSs are exempt from the SS switching criteria and irrespective of the active SS group at a time, the UE 103 can/should monitor DCI format 2-6 in the configured SSs. The same procedure can be extended to other DCI formats which are monitored by the UE 103 outside active time, e.g., all the DCI formats which are associated with the USS or Type3PDCCH-CSS, e.g., the random access response to UE 103 for bidirectional forwarding detection (BFD) outside the active time.

In some embodiments, the SS switching and thus the SS groups are not applicable to the DRX OFF duration, or at least to one of the DRX OFF duration, e.g., the long DRX OFF duration. As such, the UE 103 ignores the active SS group, and monitors the DCIs which are configured for outside the active time in their respective configured SSs irrespective of the active SS. In an example embodiment, either the network node 101 explicitly configures the UE 103 with a default SS group for the DRX OFF duration, or that the UE 103 deduces it based on a condition which is either predefined, or pre-configured or configured by the network node 101 through higher layer signaling. As such, the UE 103 is configured with a default SS group during the DRX OFF duration, in this case, the UE 103 can skip monitoring the DCIs which are associated with the SSs which are not within the default SS group, unless specific DCIs are exempt either by explicit configuration by the network node or predefinition/pre-configuration/configuration, e.g., DCI format 2-6.

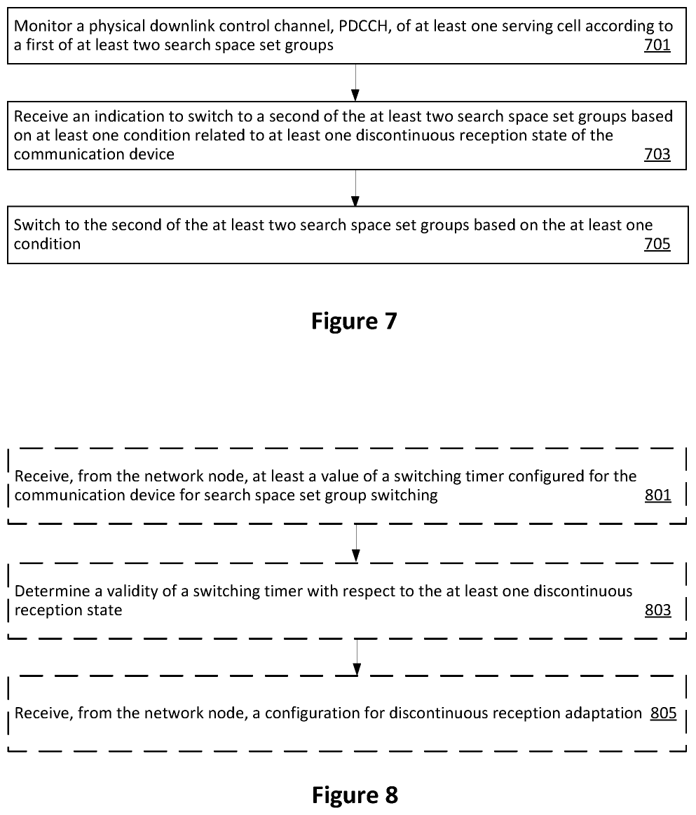

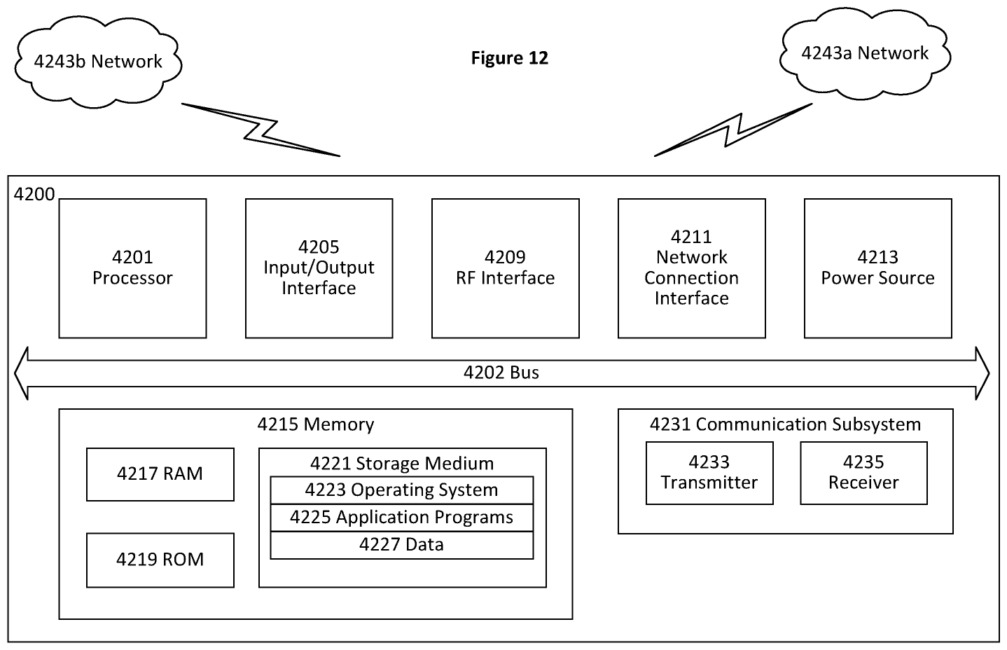

Operations specific to a communication device (e.g., communication device 103) (implemented using the structures of the block diagram of FIG. 12 discussed further herein) will now be discussed with reference to the flow charts of FIGS. 7-8 according to various embodiments of the present disclosure. For example, modules may be stored in memory 4215 of wireless device 4200 (also referred to herein as a communication device) of FIG. 12. These modules may provide instructions so that when the instructions of a module are executed by respective computer processing circuitry 4201, the processing circuitry performs respective operations of the flow charts. Each of the operations described in FIGS. 7-8 can be combined and/or omitted in any combination with each other, and it is contemplated that all such combinations fall within the spirit and scope of this disclosure.

Referring to FIGS. 7 and 8, a method performed by a communication device (e.g., 103, 4200) for search space set group switching when discontinuous reception and at least two search space set groups are configured for at least one serving cell of a communication network for the communication device is provided. The method includes monitoring (701) a physical downlink control channel, PDCCH, of the at least one serving cell according to a first of the at least two search space set groups. The method further includes receiving (703) an indication to switch to a second of the at least two search space set groups based on at least one condition related to at least one discontinuous reception state of the communication device. The method further includes switching (705) to the second of the at least two search space set groups based on the at least one condition.

In some embodiments, the first of the at least two search space set groups is configured with at least one different configuration parameter from the second of the at least two search space set groups.

In some embodiments, the at least one different configuration parameter comprises at least one of a periodicity, an offset, a duration, an aggregation level, an associated corset, a monitoring symbol within a slot, a search space type, and at least one associated downlink control information format.

In some embodiments, the indication is received from a network node or is a predefined timer for the communication device.

In some embodiments, the indication is received from a network node, or is a start of, a running of, or an expiration of a timer for the communication device.

In some embodiments, the second of the at least two search space set groups includes at least one of a pre-configured search space set group and a search space set group explicitly configured by a higher layer signaling.

In some embodiments, the search space set group explicitly configured by a higher layer signaling is configured based on at least one of a load of the network node, a quality of service of an application of the communication device, a traffic type, and other configured parameters.

In some embodiments, the at least one discontinuous reception state includes at least one of a discontinuous reception on-duration timer of a short discontinuous reception cycle, and a discontinuous reception on-duration timer of a long discontinuous reception cycle.

In some embodiments, the at least one discontinuous reception state further comprises a parameter configured for the at least one discontinuous reception state, the parameter having a value.

In some embodiments, the at least one discontinuous reception state further comprises a value configured for the at least one discontinuous reception state.

In some embodiments, the at least one condition comprises an additional condition for one or more timers associated with the at least one discontinuous reception state, a prior triggering command for a switch, and a type of discontinuous reception cycle corresponding to an on-duration timer.

In some embodiments, the at least one condition comprises (i) a parameter for one or more timers associated with the at least one discontinuous reception state, (ii) a prior triggering command for a switch, and (iii) a parameter for a type of discontinuous reception cycle corresponding to an on-duration timer that signifies to switch to the second of the at least two search space set groups.

Referring to FIG. 8, in some embodiments, the communication device is configured with search space set group switching, and the method further includes receiving (801), from the network node, at least a value of a switching timer configured for the communication device for the search space set group switching.

In some embodiments, the at least a value includes a maximum value of the switching timer.

In some embodiments, the maximum value is preconfigured based on one of a use case, and a discontinuous reception implementation in the communication device.

In some embodiments, the use case includes at least one of a frequency band, a capability of the communication device, and whether the communication is operating in a licensed or unlicensed frequency band.

In some embodiments, the maximum value is configured based on a capability report from the communication device.

In some embodiments, the capability report includes at least one of a frequency band of the communication device, a capability of the communication device, and whether the communication is operating in a licensed or unlicensed frequency band.

In some embodiments, the method further includes determining (803) a validity of a switching timer with respect to the at least one discontinuous reception state.

In some embodiments, the method further includes receiving (805), from the network node, a configuration for discontinuous reception adaptation. For example, the configuration may be a DCI format 2-6 which the communication device can/should monitor outside an active time. In an example embodiment, the configuration is a DCI format 2-6 outside the active time that can indicate to the communication device if it should monitor PDCCH during the next ON duration timer or not. A DCI format 2-6 may be associated with one or more SSs, e.g., one or more Type3-PDCCH CSS. In another example embodiment, if one or more SSs associated with the DCI format 2-6 exists in both of SS groups, the communication device monitors the DCI format 2-6 in the related SS, but if the DCI format 2-6 is only associated with one SS group, e.g., the second SS group, but at a time the first SS group is applicable, then the UE 103 does not have to monitor DCI format 2-6 and should wake up in the next ON duration timer and monitor PDCCH. Alternatively, the DCI format 2-6 outside the active time and its associated SSs are exempt from the SS switching criteria and irrespective of the active SS group at a time, the communication device can/should monitor DCI format 2-6 in the configured SSs. In some embodiments, the same procedure can be extended to other DCI formats which are monitored by the communication device outside active time, e.g., all the DCI formats which are associated with the USS or Type3PDCCH-CSS, e.g., the random access response to UE 103 for bidirectional forwarding detection (BFD) outside the active time.

The various operations of blocks 801-805 from the flow chart of FIG. 8 may be optional with respect to some embodiments. Additionally, it is noted that blocks/operations may be omitted without departing from the scope of inventive concepts. For example, blocks 803, 805 do not require the operations of block 801 and, thus in some embodiments, block 801 may be omitted. Moreover, although FIG. 8 includes arrows on communication paths to show a primary direction of communication, it is to be understood that communication may be omitted when a block is omitted.

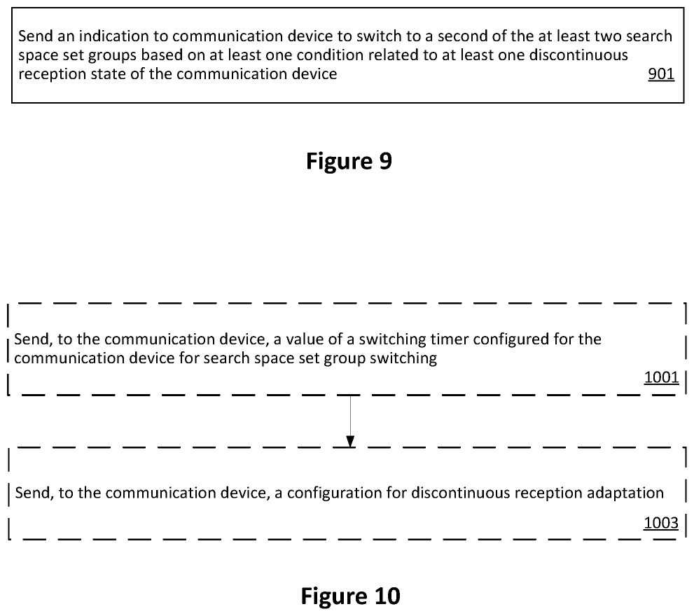

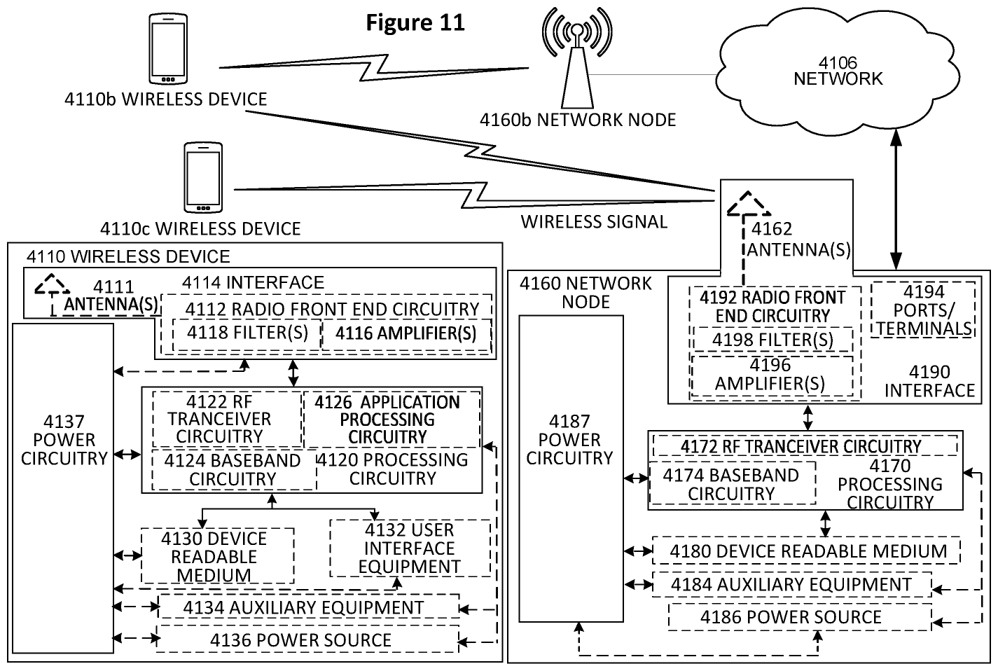

Operations specific to a network node (e.g., network node 101) (implemented using the structures of the block diagram of FIG. 11) will now be discussed with reference to the flow charts of FIGS. 9-10 according to various embodiments of the present disclosure. For example, modules may be stored in memory 4180 of network node 4160 of FIG. 11. These modules may provide instructions so that when the instructions of a module are executed by respective computer processing circuitry 4170, the processing circuitry performs respective operations of the flow charts. Each of the operations described in FIGS. 9-10 can be combined and/or omitted in any combination with each other, and it is contemplated that all such combinations fall within the spirit and scope of this disclosure.

Referring to FIGS. 9 and 10, a method performed by a network node (e.g., 101, 4160) for search space set group switching when discontinuous reception and at least two search space set groups are configured for at least one serving cell of a communication network for a communication device is provided. The method includes sending (901) an indication to the communication device to switch to a second of the at least two search space set groups based on at least one condition related to at least one discontinuous reception state of the communication device.

In some embodiments, the first of the at least two search space set groups is configured with at least one different configuration parameter from the second of that at least two search space set groups.

In some embodiments, the at least one different configuration parameter includes at least one of a periodicity, an offset, a duration, an aggregation level, an associated corset, a monitoring symbol within a slot, a search space type, and at least one associated downlink control information format.

In some embodiments, the second of the at least two search space set groups includes at least one of a pre-configured search space set group, and a search space set group explicitly configured by a higher layer signaling.

In some embodiments, the search space set group explicitly configured by a higher layer signaling is configured based on at least one of a load of the network node, a quality of service of an application of the communication device, a traffic type, and other configured parameters.

In some embodiments, the at least one discontinuous reception state includes at least one of a discontinuous reception on-duration timer of a short discontinuous reception cycle, and a discontinuous reception on-duration timer of a long discontinuous reception cycle.

In some embodiments, the at least one discontinuous reception state further includes a parameter configured for the at least one discontinuous reception state, the parameter having a value.

In some embodiments, the at least one discontinuous reception state further includes a value configured for the at least one discontinuous reception state.

In some embodiments, the at least one condition includes an additional condition for one or more timers associated with the at least one discontinuous reception state, a prior triggering command for a switch, and a type of discontinuous reception cycle corresponding to an on-duration timer.

In some embodiments, the at least one condition comprises (i) a parameter for one or more timers associated with the at least one discontinuous reception state, (ii) a prior triggering command for a switch, and (iii) a type of discontinuous reception cycle corresponding to an on-duration timer that signifies to switch to the second of the at least two search space set groups. Referring to FIG. 10, in some embodiments, the method further sending (1001), to the communication device, at least a value of a switching timer configured for the communication device for search space set group switching.

In some embodiments, the at least a value includes a maximum value.

In some embodiments, the maximum value is preconfigured based on one of a use case, and a discontinuous reception implementation in the communication device.

In some embodiments, the use case includes at least one of a frequency band, a capability of the communication device, and whether the communication is operating in a licensed or unlicensed frequency band.

In some embodiments, the maximum value is configured by the network node based on one a capability report from the communication device.

In some embodiments, the capability report includes at least one of a frequency band of the communication device, a capability of the communication device, and whether the communication is operating in a licensed or unlicensed frequency band.

In some embodiments, the method further includes sending (1003), to the communication device, a configuration for discontinuous reception adaptation.

The various operations of blocks 1001-1003 from the flow chart of FIG. 10 may be optional with respect to some embodiments. Additionally, it is noted that blocks/operations may be omitted without departing from the scope of inventive concepts. For example, block 1003 does not require the operations of block 1001 and, thus in some embodiments, block 1001 may be omitted. Moreover, although FIG. 10 includes arrows on communication paths to show a primary direction of communication, it is to be understood that communication may be omitted when a block is omitted.

Example Embodiments are discussed below. Reference numbers/letters are provided in parenthesis by way of example/illustration without limiting example embodiments to particular elements indicated by reference numbers/letters.
1. A method performed by a communication device (103, 4200) for search space set group switching when discontinuous reception and at least two search space set groups are configured for at least one serving cell of a communication network for the communication device, the method comprising:
monitoring (701) a physical downlink control channel, PDCCH, of the at least one serving cell according to a first of the at least two search space set groups;
receiving (703) an indication to switch to a second of the at least two search space set groups based on at least one condition related to at least one discontinuous reception state of the communication device; and
switching (705) to the second of the at least two search space set groups based on the at least one condition.
2. The method of Embodiment 1, wherein the first of that at least two search space set groups is configured with at least one different configuration parameter from the second of the at least two search space set groups.
3. The method of Embodiment 2, wherein the at least one different configuration parameter comprises at least one of a periodicity, an offset, a duration, an aggregation level, an associated corset, a monitoring symbol within a slot, a search space type, and at least one associated downlink control information format.
4. The method of any of Embodiments 1-3, wherein the indication is received from a network node or is a predefined timer for the communication device.
5. The method of any of Embodiments 1-4, wherein the indication is received from a network node, or is a start of, a running of, or an expiration of a timer for the communication device.
6. The method of any of Embodiments 1-5, wherein the second of the at least two search space set groups comprises at least one of a pre-configured search space set group and a search space set group explicitly configured by a higher layer signaling.
7. The method of Embodiment 6, wherein the search space set group explicitly configured by a higher layer signaling is configured based on at least one of a load of the network node, a quality of service of an application of the communication device, a traffic type, and other configured parameters.
8. The method of any of Embodiments 1-7, wherein the at least one discontinuous reception state comprises at least one of a discontinuous reception on-duration timer of a short discontinuous reception cycle, and a discontinuous reception on-duration timer of a long discontinuous reception cycle.
9. The method of Embodiment 8, wherein the at least one discontinuous reception state further comprises a parameter configured for the at least one discontinuous reception state, the parameter having a value.
10. The method of Embodiment 8, wherein the at least one discontinuous reception state further comprises a value configured for the at least one discontinuous reception state.
11. The method of any of Embodiments 1-10, wherein the at least one condition comprises an additional condition for one or more timers associated with the at least one discontinuous reception state, a prior triggering command for a switch, and a type of discontinuous reception cycle corresponding to an on-duration timer.
12. The method of any of Embodiments 1-11, wherein the at least one condition comprises (i) a parameter for one or more timers associated with the at least one discontinuous reception state, (ii) a prior triggering command for a switch, and (iii) a type of discontinuous reception cycle corresponding to an on-duration timer that signifies to switch to the second of the at least two search space set groups.
13. The method of any of Embodiments 1-12, wherein the communication device is configured with search space set group switching, and further comprising:
receiving (801), from the network node, a value of a switching timer configured for the communication device for the search space set group switching.
14. The method of Embodiment 13, wherein the value comprises a maximum value of the switching timer.
15. The method of Embodiment 14, wherein the maximum value is preconfigured based on one of a use case, and a discontinuous reception implementation in the communication device.
16. The method of Embodiment 15, wherein the use case comprises at least one of a frequency band, a capability of the communication device, and whether the communication is operating in a licensed or unlicensed frequency band.
17. The method of Embodiment 14, wherein the maximum value is configured by a network node based on a capability report from the communication device.
18. The method of Embodiment 17, wherein the capability report comprises at least one of a frequency band of the communication device, a capability of the communication device, and whether the communication is operating in a licensed or unlicensed frequency band.
19. The method of any of Embodiments 1-18, further comprising:
determining (803) a validity of a switching timer with respect to the at least one discontinuous reception state.
20. The method of any of Embodiments 1-19, further comprising:
receiving (805), from the network node, a configuration for discontinuous reception adaptation.
21. A communication device (103, 4200) in a communications network (105), the communication device configured with discontinuous reception and at least two search space set groups for at least one serving cell of a communication network, the communication device comprising:
processing circuitry (4201);
memory (4215) coupled with the processing circuitry, wherein the memory includes instructions that when executed by the processing circuitry causes the communication device to perform operations comprising:
monitor a physical downlink control channel, PDCCH, of the at least one serving cell according to a first of the at least two search space set groups;
receive an indication to switch to a second of the at least two search space set group based on at least one condition related to at least one discontinuous reception state of the communication device; and
switch to the second of the at least two search space set groups based on the at least one condition.
22. The communication device of Embodiment 21, the operations further comprising any of the operations of Embodiments 2-20.
23. A computer program comprising program code to be executed by a communication device (103, 4200), the communication device configured with discontinuous reception and at least two search space set groups for at least one serving cell of a communication network, to perform operations comprising:
monitoring (701) a physical downlink control channel, PDCCH, of the at least one serving cell according to a first of the at least two search space set groups;
receiving (703) an indication to switch to a second of the at least two search space set groups based on at least one condition related to at least one discontinuous reception state of the communication device; and
switching (705) to the second of the at least two search space set groups based on the at least one condition.
24. The computer program of Embodiment 23, the operations further comprising any of the operations of Embodiments 2-20.
25. A computer program product comprising a non-transitory storage medium (4251) including program code to be executed by processing circuitry (4201) of a communication device (103, 4200), the communication device configured with discontinuous reception and at least two search space set groups for at least one serving cell of a communication network, whereby execution of the program code causes the communication device to perform operations comprising:
monitoring (701) a physical downlink control channel, PDCCH, of the at least one serving cell according to a first of the at least two search space set groups;
receiving (703) an indication to switch to a second of the at least two search space set groups based on at least one condition related to at least one discontinuous reception state of the communication device; and
switching (705) to the second of the at least two search space set groups based on the at least one condition.
26. The computer program product of Embodiment 25, the operations further comprising any of the operations of Embodiments 2-20.
27. A method performed by a network node (101, 4160) for search space set group switching when discontinuous reception and at least two search space set groups are configured for at least one serving cell of a communication network for a communication device, the method comprising:
sending (901) an indication to the communication device to switch to a second of the at least two search space set groups based on at least one condition related to at least one discontinuous reception state of the communication device.
28. The method of Embodiment 27, wherein the first of the at least two search space set groups is configured with at least one different configuration parameter from the second of the at least two search space set groups.
29. The method of Embodiment 28, wherein the at least one different configuration parameter comprises at least one of a periodicity, an offset, a duration, an aggregation level, an associated corset, a monitoring symbol within a slot, a search space type, and at least one associated downlink control information format.
30. The method of any of Embodiments 27-29, wherein the second of the at least two search space set groups comprises at least one of a pre-configured search space set group, and a search space set group explicitly configured by a higher layer signaling.
31. The method of any of Embodiments 27-30, wherein the search space set group explicitly configured by a higher layer signaling is configured based on at least one of a load of the network node, a quality of service of an application of the communication device, a traffic type, and other configured parameters.
32. The method of any of Embodiments 27-30, wherein the at least one discontinuous reception state comprises at least one of a discontinuous reception on-duration timer of a short discontinuous reception cycle, and a discontinuous reception on-duration timer of a long discontinuous reception cycle.
33. The method of Embodiment 32, wherein the at least one discontinuous reception state further comprises a parameter configured for the at least one discontinuous reception state, the parameter having a value.
34. The method of any of Embodiments 27-33 wherein the at least one condition comprises an additional condition for one or more timers associated with the at least one discontinuous reception state, a prior triggering command for a switch, and a type of discontinuous reception cycle corresponding to an on-duration timer.
35. The method of any of Embodiments 27-33, wherein the at least one condition comprises (i) a parameter for one or more timers associated with the at least one discontinuous reception state, (ii) a prior triggering command for a switch, and (iii) a type of discontinuous reception cycle corresponding to an on-duration timer that signifies to switch to the second of the at least two search space set groups.
36. The method of any of Embodiments 27-35, further comprising:
sending (1001), to the communication device, a value of a switching timer configured for the communication device for search space set group switching.
37. The method of Embodiment 36, wherein the value comprises a maximum value.
38. The method of Embodiment 37, wherein the maximum value is preconfigured based on one of a use case, and a discontinuous reception implementation in the communication device.
39. The method of Embodiment 38, wherein the use case comprises at least one of a frequency band, a capability of the communication device, and whether the communication is operating in a licensed or unlicensed frequency band.
40. The method of Embodiment 37, wherein the maximum value is configured by the network node based on one a capability report from the communication device.
41. The method of Embodiment 40, wherein the capability report comprises at least one of a frequency band of the communication device, a capability of the communication device, and whether the communication is operating in a licensed or unlicensed frequency band.
42. The method of any of Embodiments 27-41, further comprising:
sending (1003), to the communication device, a configuration for discontinuous reception adaptation.
43. A network node (101, 4160) in a communication network (105), the network node comprising:
processing circuitry (4170);
memory (4180) coupled with the processing circuitry, wherein the memory includes instructions that when executed by the processing circuitry causes the network node, for operations related to search space set group switching operations when discontinuous reception and at least two search space set groups are configured for at least one serving cell of a communication network for a communication device, to perform operations comprising:
send, to the communication device, an indication to switch to a second of the at least two search space set groups based on at least one condition related to at least one discontinuous reception state of the communication device.
44. The network node of Embodiment 43, the operations further comprising any of the operations of Embodiments 28-42.
45. A computer program comprising program code to be executed by a network node (101, 4160), for operations related to search space set group switching operations when discontinuous reception and at least two search space set groups are configured for at least one serving cell of a communication network for a communication device, to perform operations comprising:
sending (901) an indication to the communication device to switch to a second of the at least two search space set groups based on at least one condition related to at least one discontinuous reception state of the communication device.
46. The computer program of Embodiment 45, the operations further comprising any of the operations of Embodiments 28-42.
47. A computer program product comprising a non-transitory storage medium (4180) including program code to be executed by processing circuitry (4170) of a network node (101, 4160), for operations related to search space set group switching operations when discontinuous reception and at least two search space set groups are configured for at least one serving cell of a communication network for a communication device, whereby execution of the program code causes the network node to perform operations comprising:
sending (901) an indication to the communication device to switch to a second of the at least two search space set groups based on at least one condition related to at least one discontinuous reception state of the communication device.
48. The computer program product of Embodiment 47, the operations further comprising any of the operations of Embodiments 28-42.

Further definitions and embodiments are discussed below:

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 11: A wireless network in accordance with some embodiments.

Although the subject matter described herein may be implemented in any appropriate type of system using any suitable components, the embodiments disclosed herein are described in relation to a wireless network, such as the example wireless network illustrated in FIG. 11. For simplicity, the wireless network of FIG. 11 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 11, network node 4160 includes processing circuitry 4170, device readable medium 4180, interface 4190, auxiliary equipment 4184, power source 4186, power circuitry 4187, and antenna 4162. Although network node QQ160 illustrated in the example wireless network of FIG. 11 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and a RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units.

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4190 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 11 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE or other terminal implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, WiMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4114 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner. In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated. User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a USB port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

FIG. 12: User Equipment in accordance with some embodiments

FIG. 12 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

Alternatively, a UE may represent a device that is not intended for sale to, or operation by, an end user but which may be associated with or operated for the benefit of a user (e.g., a smart power meter). UE 42200 may be any UE identified by the 3rd Generation Partnership Project (3GPP), including a NB-IoT UE, a machine type communication (MTC) UE, and/or an enhanced MTC (eMTC) UE. UE 4200, as illustrated in FIG. 12, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 12 is a UE, the components discussed herein are equally applicable to a WD, and vice-versa.

In FIG. 12, UE 4200 includes processing circuitry 4201 that is operatively coupled to input/output interface 4205, radio frequency (RF) interface 4209, network connection interface 4211, memory 4215 including random access memory (RAM) 4217, read-only memory (ROM) 4219, and storage medium 4221 or the like, communication subsystem 4231, power source 4233, and/or any other component, or any combination thereof. Storage medium 4221 includes operating system 4223, application program 4225, and data 4227. In other embodiments, storage medium 4221 may include other similar types of information. Certain UEs may utilize all of the components shown in FIG. 12, or only a subset of the components. The level of integration between the components may vary from one UE to another UE. Further, certain UEs may contain multiple instances of a component, such as multiple processors, memories, transceivers, transmitters, receivers, etc.

In FIG. 12, processing circuitry 4201 may be configured to process computer instructions and data. Processing circuitry 4201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 4201 may include two central processing units (CPUs). Data may be information in a form suitable for use by a computer.

In the depicted embodiment, input/output interface 4205 may be configured to provide a communication interface to an input device, output device, or input and output device. UE 4200 may be configured to use an output device via input/output interface 4205. An output device may use the same type of interface port as an input device. For example, a USB port may be used to provide input to and output from UE 4200. The output device may be a speaker, a sound card, a video card, a display, a monitor, a printer, an actuator, an emitter, a smartcard, another output device, or any combination thereof. UE 4200 may be configured to use an input device via input/output interface 4205 to allow a user to capture information into UE 4200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 12, RF interface 4209 may be configured to provide a communication interface to RF components such as a transmitter, a receiver, and an antenna. Network connection interface 4211 may be configured to provide a communication interface to network 4243a. Network 4243a may encompass wired and/or wireless networks such as a local-area network (LAN), a wide-area network (WAN), a computer network, a wireless network, a telecommunications network, another like network or any combination thereof. For example, network 4243a may comprise a Wi-Fi network. Network connection interface 4211 may be configured to include a receiver and a transmitter interface used to communicate with one or more other devices over a communication network according to one or more communication protocols, such as Ethernet, TCP/IP, SONET, ATM, or the like. Network connection interface 4211 may implement receiver and transmitter functionality appropriate to the communication network links (e.g., optical, electrical, and the like). The transmitter and receiver functions may share circuit components, software or firmware, or alternatively may be implemented separately.

RAM 4217 may be configured to interface via bus 4202 to processing circuitry 4201 to provide storage or caching of data or computer instructions during the execution of software programs such as the operating system, application programs, and device drivers. ROM 4219 may be configured to provide computer instructions or data to processing circuitry 4201. For example, ROM 4219 may be configured to store invariant low-level system code or data for basic system functions such as basic input and output (I/O), startup, or reception of keystrokes from a keyboard that are stored in a non-volatile memory. Storage medium 4221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 4221 may be configured to include operating system 4223, application program 4225 such as a web browser application, a widget or gadget engine or another application, and data file 4227. Storage medium 4221 may store, for use by UE 4200, any of a variety of various operating systems or combinations of operating systems.

Storage medium 4221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 4221 may allow UE 4200 to access computer-executable instructions, application programs or the like, stored on transitory or non-transitory memory media, to off-load data, or to upload data. An article of manufacture, such as one utilizing a communication system may be tangibly embodied in storage medium 4221, which may comprise a device readable medium.

In FIG. 12, processing circuitry 4201 may be configured to communicate with network 4243_{b} using communication subsystem 4231. Network 4243a and network 4243b may be the same network or networks or different network or networks. Communication subsystem 4231 may be configured to include one or more transceivers used to communicate with network 4243b. For example, communication subsystem 4231 may be configured to include one or more transceivers used to communicate with one or more remote transceivers of another device capable of wireless communication such as another WD, UE, or base station of a radio access network (RAN) according to one or more communication protocols, such as IEEE 802.QQ2, CDMA, WCDMA, GSM, LTE, UTRAN, WiMax, or the like. Each transceiver may include transmitter 4233 and/or receiver 4235 to implement transmitter or receiver functionality, respectively, appropriate to the RAN links (e.g., frequency allocations and the like). Further, transmitter 4233 and receiver 4235 of each transceiver may share circuit components, software or firmware, or alternatively may be implemented separately.

In the illustrated embodiment, the communication functions of communication subsystem 4231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 4231 may include cellular communication, Wi-Fi communication, Bluetooth communication, and GPS communication. Network 4243b may encompass wired and/or wireless networks such as a local-area network (LAN), a wide-area network (WAN), a computer network, a wireless network, a telecommunications network, another like network or any combination thereof. For example, network 4243b may be a cellular network, a Wi-Fi network, and/or a near-field network. Power source 4213 may be configured to provide alternating current (AC) or direct current (DC) power to components of UE 4200.

The features, benefits and/or functions described herein may be implemented in one of the components of UE 4200 or partitioned across multiple components of UE 4200. Further, the features, benefits, and/or functions described herein may be implemented in any combination of hardware, software or firmware. In one example, communication subsystem 4231 may be configured to include any of the components described herein. Further, processing circuitry 4201 may be configured to communicate with any of such components over bus 4202. In another example, any of such components may be represented by program instructions stored in memory that when executed by processing circuitry 4201 perform the corresponding functions described herein. In another example, the functionality of any of such components may be partitioned between processing circuitry 4201 and communication subsystem 4231. In another example, the non-computationally intensive functions of any of such components may be implemented in software or firmware and the computationally intensive functions may be implemented in hardware.

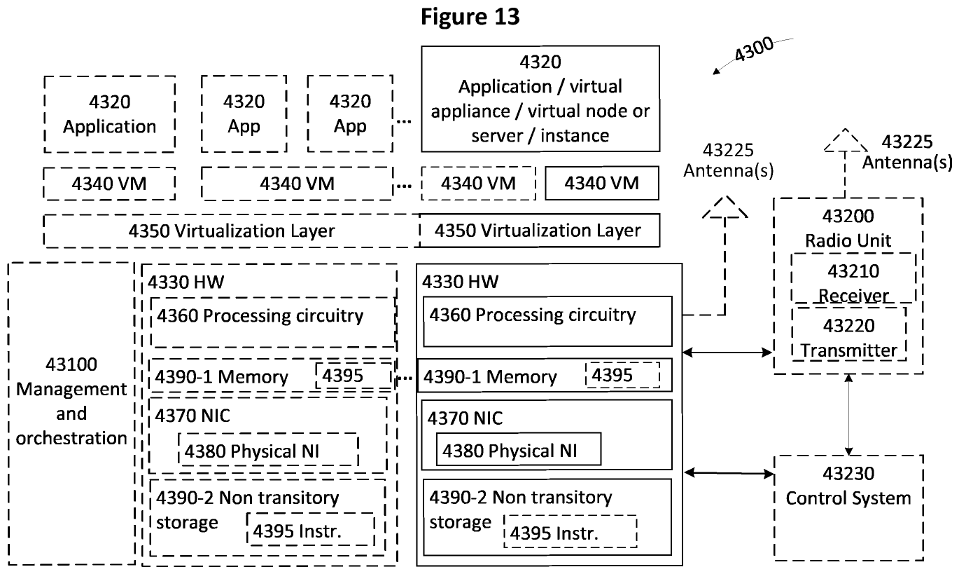

FIG. 13: Virtualization environment in accordance with some embodiments

FIG. 13 is a schematic block diagram illustrating a virtualization environment 4300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 4300 hosted by one or more of hardware nodes 4330. Further, in embodiments in which the virtual node is not a radio access node or does not require radio connectivity (e.g., a core network node), then the network node may be entirely virtualized.

The functions may be implemented by one or more applications 4320 (which may alternatively be called software instances, virtual appliances, network functions, virtual nodes, virtual network functions, etc.) operative to implement some of the features, functions, and/or benefits of some of the embodiments disclosed herein. Applications 4320 are run in virtualization environment 4300 which provides hardware 4330 comprising processing circuitry 4360 and memory 4390. Memory 4390 contains instructions 4395 executable by processing circuitry 4360 whereby application 4320 is operative to provide one or more of the features, benefits, and/or functions disclosed herein.

Virtualization environment 4300, comprises general-purpose or special-purpose network hardware devices 4330 comprising a set of one or more processors or processing circuitry 4360, which may be commercial off-the-shelf (COTS) processors, dedicated Application Specific Integrated Circuits (ASICs), or any other type of processing circuitry including digital or analog hardware components or special purpose processors. Each hardware device may comprise memory 4390-1 which may be non-persistent memory for temporarily storing instructions 4395 or software executed by processing circuitry 4360. Each hardware device may comprise one or more network interface controllers (NICs) 4370, also known as network interface cards, which include physical network interface 4380. Each hardware device may also include non-transitory, persistent, machine-readable storage media 4390-2 having stored therein software 4395 and/or instructions executable by processing circuitry 4360. Software 4395 may include any type of software including software for instantiating one or more virtualization layers 4350 (also referred to as hypervisors), software to execute virtual machines 4340 as well as software allowing it to execute functions, features and/or benefits described in relation with some embodiments described herein.

Virtual machines 4340, comprise virtual processing, virtual memory, virtual networking or interface and virtual storage, and may be run by a corresponding virtualization layer 4350 or hypervisor. Different embodiments of the instance of virtual appliance 4320 may be implemented on one or more of virtual machines 4340, and the implementations may be made in different ways.

During operation, processing circuitry 4360 executes software 4395 to instantiate the hypervisor or virtualization layer 4350, which may sometimes be referred to as a virtual machine monitor (VMM). Virtualization layer 4350 may present a virtual operating platform that appears like networking hardware to virtual machine 4340.

As shown in FIG. 13, hardware 4330 may be a standalone network node with generic or specific components. Hardware 4330 may comprise antenna 43225 and may implement some functions via virtualization. Alternatively, hardware 4330 may be part of a larger cluster of hardware (e.g. such as in a data center or customer premise equipment (CPE)) where many hardware nodes work together and are managed via management and orchestration (MANO) 43100, which, among others, oversees lifecycle management of applications 4320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 4340 may be a software implementation of a physical machine that runs programs as if they were executing on a physical, non-virtualized machine. Each of virtual machines 4340, and that part of hardware 4330 that executes that virtual machine, be it hardware dedicated to that virtual machine and/or hardware shared by that virtual machine with others of the virtual machines 4340, forms a separate virtual network elements (VNE).

Still in the context of NFV, Virtual Network Function (VNF) is responsible for handling specific network functions that run in one or more virtual machines 4340 on top of hardware networking infrastructure 4330 and corresponds to application 4320 in FIG. 13.

In some embodiments, one or more radio units 43200 that each include one or more transmitters 43220 and one or more receivers 43210 may be coupled to one or more antennas 43225. Radio units 43200 may communicate directly with hardware nodes 4330 via one or more appropriate network interfaces and may be used in combination with the virtual components to provide a virtual node with radio capabilities, such as a radio access node or a base station.

In some embodiments, some signalling can be effected with the use of control system 43230 which may alternatively be used for communication between the hardware nodes 4330 and radio units 43200.

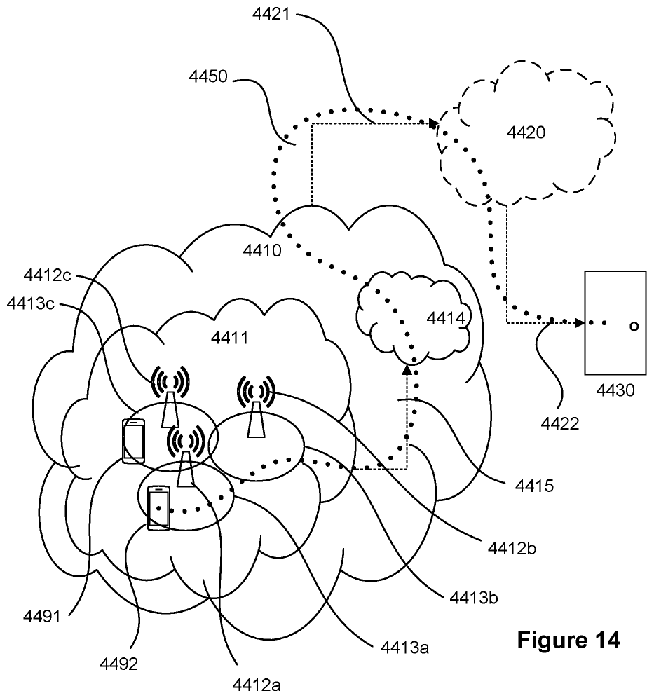

FIG. 14: Telecommunication network connected via an intermediate network to a host computer in accordance with some embodiments.

With reference to FIG. 14, in accordance with an embodiment, a communication system includes telecommunication network 4410, such as a 3GPP-type cellular network, which comprises access network 4411, such as a radio access network, and core network 4414. Access network 4411 comprises a plurality of base stations 4412a, 4412b, 4412c, such as NBs, eNBs, gNBs or other types of wireless access points, each defining a corresponding coverage area 4413a, 4413b, 4413c. Each base station 4412a, 4412b, 4412c is connectable to core network 4414 over a wired or wireless connection 4415. A first UE 4491 located in coverage area 4413c is configured to wirelessly connect to, or be paged by, the corresponding base station 4412c. A second UE 4492 in coverage area 4413a is wirelessly connectable to the corresponding base station 4412a. While a plurality of UEs 4491, 4492 are illustrated in this example, the disclosed embodiments are equally applicable to a situation where a sole UE is in the coverage area or where a sole UE is connecting to the corresponding base station 4412.

Telecommunication network 4410 is itself connected to host computer 4430, which may be embodied in the hardware and/or software of a standalone server, a cloud-implemented server, a distributed server or as processing resources in a server farm. Host computer 4430 may be under the ownership or control of a service provider, or may be operated by the service provider or on behalf of the service provider. Connections 4421 and 4422 between telecommunication network 4410 and host computer 4430 may extend directly from core network 4414 to host computer 4430 or may go via an optional intermediate network 4420. Intermediate network 4420 may be one of, or a combination of more than one of, a public, private or hosted network; intermediate network 4420, if any, may be a backbone network or the Internet; in particular, intermediate network 4420 may comprise two or more sub-networks (not shown).

The communication system of FIG. 14 as a whole enables connectivity between the connected UEs 4491, 4492 and host computer 4430. The connectivity may be described as an over-the-top (OTT) connection 4450. Host computer 4430 and the connected UEs 4491, 4492 are configured to communicate data and/or signaling via OTT connection 4450, using access network 4411, core network 4414, any intermediate network 4420 and possible further infrastructure (not shown) as intermediaries. OTT connection 4450 may be transparent in the sense that the participating communication devices through which OTT connection 4450 passes are unaware of routing of uplink and downlink communications. For example, base station 4412 may not or need not be informed about the past routing of an incoming downlink communication with data originating from host computer 4430 to be forwarded (e.g., handed over) to a connected UE 4491. Similarly, base station 4412 need not be aware of the future routing of an outgoing uplink communication originating from the UE 4491 towards the host computer 4430.

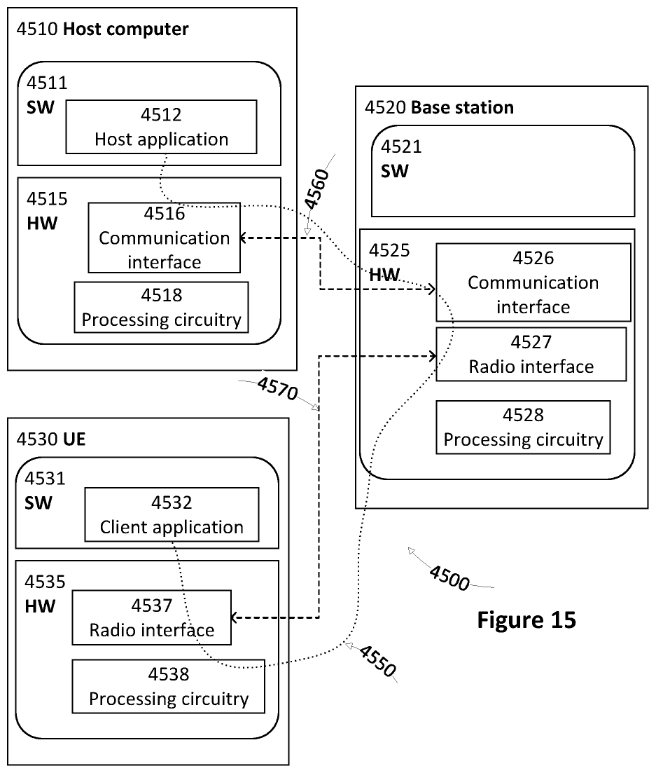

FIG. 15: Host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 15. In communication system 4500, host computer 4510 comprises hardware 4515 including communication interface 4516 configured to set up and maintain a wired or wireless connection with an interface of a different communication device of communication system 4500. Host computer 4510 further comprises processing circuitry 4518, which may have storage and/or processing capabilities. In particular, processing circuitry 4518 may comprise one or more programmable processors, application-specific integrated circuits, field programmable gate arrays or combinations of these (not shown) adapted to execute instructions. Host computer 4510 further comprises software 4511, which is stored in or accessible by host computer 4510 and executable by processing circuitry 4518. Software 4511 includes host application 4512. Host application 4512 may be operable to provide a service to a remote user, such as UE 4530 connecting via OTT connection 4550 terminating at UE 4530 and host computer 4510. In providing the service to the remote user, host application 4512 may provide user data which is transmitted using OTT connection 4550.

Communication system 4500 further includes base station 4520 provided in a telecommunication system and comprising hardware 4525 enabling it to communicate with host computer 4510 and with UE 4530. Hardware 4525 may include communication interface 4526 for setting up and maintaining a wired or wireless connection with an interface of a different communication device of communication system 4500, as well as radio interface 4527 for setting up and maintaining at least wireless connection 4570 with UE 4530 located in a coverage area (not shown in FIG. 15) served by base station 4520. Communication interface 4526 may be configured to facilitate connection 4560 to host computer 4510. Connection 4560 may be direct or it may pass through a core network (not shown in FIG. 15) of the telecommunication system and/or through one or more intermediate networks outside the telecommunication system. In the embodiment shown, hardware 4525 of base station 4520 further includes processing circuitry 4528, which may comprise one or more programmable processors, application-specific integrated circuits, field programmable gate arrays or combinations of these (not shown) adapted to execute instructions. Base station 4520 further has software 4521 stored internally or accessible via an external connection.

Communication system 4500 further includes UE 4530 already referred to. Its hardware 4535 may include radio interface 4537 configured to set up and maintain wireless connection 4570 with a base station serving a coverage area in which UE 4530 is currently located. Hardware 4535 of UE 4530 further includes processing circuitry 4538, which may comprise one or more programmable processors, application-specific integrated circuits, field programmable gate arrays or combinations of these (not shown) adapted to execute instructions. UE 4530 further comprises software 4531, which is stored in or accessible by UE 4530 and executable by processing circuitry 4538. Software 4531 includes client application 4532. Client application 4532 may be operable to provide a service to a human or non-human user via UE 4530, with the support of host computer 4510. In host computer 4510, an executing host application 4512 may communicate with the executing client application 4532 via OTT connection 4550 terminating at UE 4530 and host computer 4510. In providing the service to the user, client application 4532 may receive request data from host application 4512 and provide user data in response to the request data. OTT connection 4550 may transfer both the request data and the user data. Client application 4532 may interact with the user to generate the user data that it provides.

It is noted that host computer 4510, base station 4520 and UE 4530 illustrated in FIG. 15 may be similar or identical to host computer 4430, one of base stations 4412a, 4412b, 4412c and one of UEs 4491, 4492 of FIG. 14, respectively. This is to say, the inner workings of these entities may be as shown in FIG. 15 and independently, the surrounding network topology may be that of FIG. 14.

In FIG. 15, OTT connection 4550 has been drawn abstractly to illustrate the communication between host computer 4510 and UE 4530 via base station 4520, without explicit reference to any intermediary devices and the precise routing of messages via these devices. Network infrastructure may determine the routing, which it may be configured to hide from UE 4530 or from the service provider operating host computer 4510, or both. While OTT connection 4550 is active, the network infrastructure may further take decisions by which it dynamically changes the routing (e.g., on the basis of load balancing consideration or reconfiguration of the network).

Wireless connection 4570 between UE 4530 and base station 4520 is in accordance with the teachings of the embodiments described throughout this disclosure. One or more of the various embodiments may improve the performance of OTT services provided to UE 4530 using OTT connection 4550, in which wireless connection 4570 forms the last segment. More precisely, the teachings of these embodiments may improve the deblock filtering for video processing and thereby provide benefits such as improved video encoding and/or decoding A measurement procedure may be provided for the purpose of monitoring data rate, latency and other factors on which the one or more embodiments improve. There may further be an optional network functionality for reconfiguring OTT connection 4550 between host computer 4510 and UE 4530, in response to variations in the measurement results. The measurement procedure and/or the network functionality for reconfiguring OTT connection 4550 may be implemented in software 4511 and hardware 4515 of host computer 4510 or in software 4531 and hardware 4535 of UE 4530, or both. In embodiments, sensors (not shown) may be deployed in or in association with communication devices through which OTT connection 4550 passes; the sensors may participate in the measurement procedure by supplying values of the monitored quantities exemplified above, or supplying values of other physical quantities from which software 4511, 4531 may compute or estimate the monitored quantities. The reconfiguring of OTT connection 4550 may include message format, retransmission settings, preferred routing etc.; the reconfiguring need not affect base station 4520, and it may be unknown or imperceptible to base station 4520. Such procedures and functionalities may be known and practiced in the art. In certain embodiments, measurements may involve proprietary UE signaling facilitating host computer 4510's measurements of throughput, propagation times, latency and the like. The measurements may be implemented in that software 4511 and 4531 causes messages to be transmitted, in particular empty or ‘dummy’ messages, using OTT connection 4550 while it monitors propagation times, errors etc.

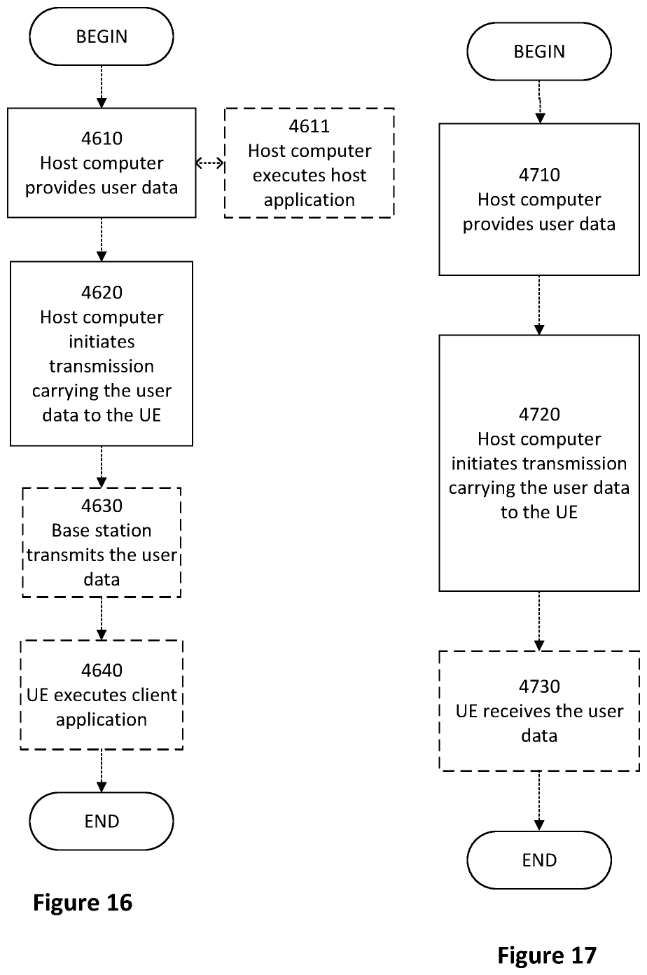

FIG. 16: Methods implemented in a communication system including a host computer, a base station and a user equipment in accordance with some embodiments.

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In step 4610, the host computer provides user data. In substep 4611 (which may be optional) of step 4610, the host computer provides the user data by executing a host application. In step 4620, the host computer initiates a transmission carrying the user data to the UE. In step 4630 (which may be optional), the base station transmits to the UE the user data which was carried in the transmission that the host computer initiated, in accordance with the teachings of the embodiments described throughout this disclosure. In step 4640 (which may also be optional), the UE executes a client application associated with the host application executed by the host computer.

FIG. 17: Methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In step 4710 of the method, the host computer provides user data. In an optional substep (not shown) the host computer provides the user data by executing a host application. In step 4720, the host computer initiates a transmission carrying the user data to the UE. The transmission may pass via the base station, in accordance with the teachings of the embodiments described throughout this disclosure. In step 4730 (which may be optional), the UE receives the user data carried in the transmission.

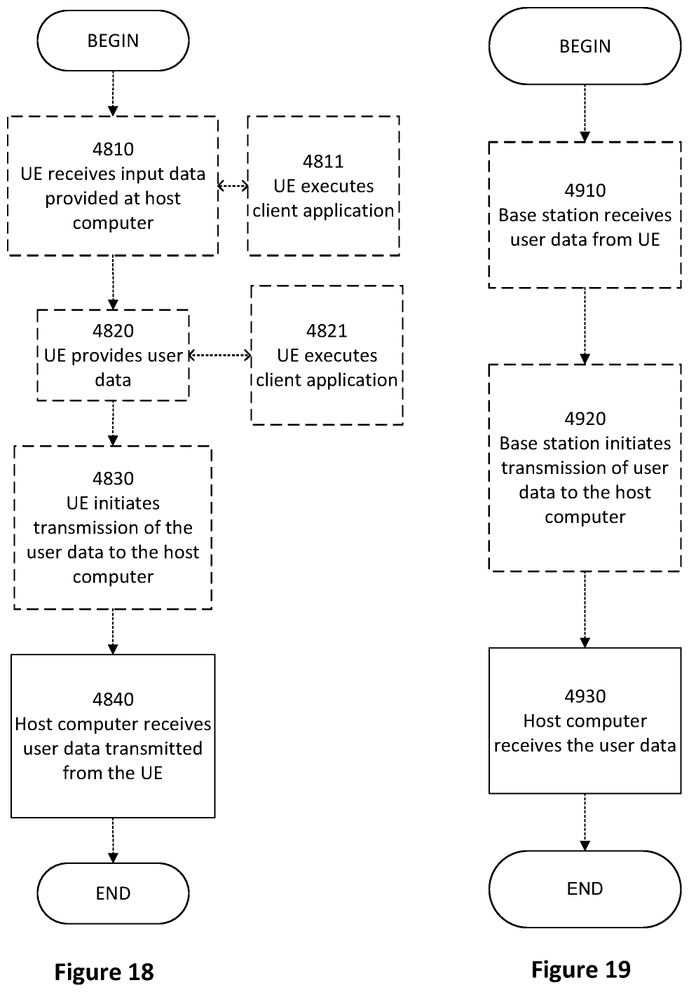

FIG. 18: Methods implemented in a communication system including a host computer, a base station and a user equipment in accordance with some embodiments.

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In step 4810 (which may be optional), the UE receives input data provided by the host computer. Additionally or alternatively, in step 4820, the UE provides user data. In substep 4821 (which may be optional) of step 4820, the UE provides the user data by executing a client application. In substep 4811 (which may be optional) of step 4810, the UE executes a client application which provides the user data in reaction to the received input data provided by the host computer. In providing the user data, the executed client application may further consider user input received from the user. Regardless of the specific manner in which the user data was provided, the UE initiates, in substep 4830 (which may be optional), transmission of the user data to the host computer. In step 4840 of the method, the host computer receives the user data transmitted from the UE, in accordance with the teachings of the embodiments described throughout this disclosure.

FIG. 18: Methods implemented in a communication system including a host computer, a base station and a user equipment in accordance with some embodiments.

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In step 4910 (which may be optional), in accordance with the teachings of the embodiments described throughout this disclosure, the base station receives user data from the UE. In step 4920 (which may be optional), the base station initiates transmission of the received user data to the host computer. In step 4930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method performed by a communication device for search space set group switching when discontinuous reception and at least two search space set groups are configured for at least one serving cell of a communication network for the communication device, the method comprising:
monitoring a physical downlink control channel, PDCCH, of the at least one serving cell according to a first of the at least two search space set groups;
receiving an indication to switch to a second of the at least two search space set groups based on at least one condition related to at least one discontinuous reception state of the communication device; and
switching to the second of the at least two search space set groups based on the at least one condition.

2. The method of claim 1, wherein the first of the at least two search space set groups is configured with at least one different configuration parameter from the second of the at least two search space set groups.

3. The method of claim 2, wherein the at least one different configuration parameter comprises at least one of a periodicity, an offset, a duration, an aggregation level, an associated corset, a monitoring symbol within a slot, a search space type, and at least one associated downlink control information format.

4. The method of claim 1, wherein the indication is received from a network node, or is a start of, a running of, or an expiration of a timer for the communication device.

5. The method of claim 1, wherein the second of the at least two search space set groups comprises at least one of a pre-configured search space set group and a search space set group explicitly configured by a higher layer signaling.

6. The method of claim 5, wherein the search space set group explicitly configured by a higher layer signaling is configured based on at least one of a load of the network node, a quality of service of an application of the communication device, a traffic type, and other configured parameters.

7. The method of claim 1, wherein the at least one discontinuous reception state comprises at least one of a discontinuous reception on-duration timer of a short discontinuous reception cycle, and a discontinuous reception on-duration timer of a long discontinuous reception cycle.

8. The method of claim 7, wherein the at least one discontinuous reception state further comprises a value configured for the at least one discontinuous reception state.

9. The method of claim 1, wherein the at least one condition comprises (i) a parameter for one or more timers associated with the at least one discontinuous reception state, (ii) a prior triggering command for a switch, and (iii) a type of discontinuous reception cycle corresponding to an on-duration timer that signifies to switch to the second of the at least two search space set groups.

10. The method of claim 1, wherein the communication device is configured with search space set group switching, and further comprising:
receiving, from the network node, at least a value of a switching timer configured for the communication device for the search space set group switching.

11. The method of claim 10, wherein the at least a value comprises a maximum value of the switching timer.

12. The method of claim 11, wherein the maximum value is configured based on a capability report from the communication device.

13. The method of claim 12, wherein the capability report comprises at least one of a frequency band of the communication device, a capability of the communication device, and whether the communication is operating in a licensed or unlicensed frequency band.

14. The method of claim 1, further comprising:
determining a validity of a switching timer with respect to the at least one discontinuous reception state.

15. The method of claim 1, further comprising:
receiving, from the network node, a configuration for discontinuous reception adaptation.

16-21. (canceled)

22. A method performed by a network node for search space set group switching when discontinuous reception and at least two search space set groups are configured for at least one serving cell of a communication network for a communication device, the method comprising:
sending an indication to the communication device to switch to a second of the at least two search space set groups based on at least one condition related to at least one discontinuous reception state of the communication device.

23. The method of claim 22, wherein
first of the least two search space set groups is configured with at least one different configuration parameter from the second of the at least two search space set groups, and
the second of the at least two search space set groups comprises at least one of a pre-configured search space set group and a search space set group explicitly configured by a higher layer signaling.

24. The method of claim 23, wherein the at least one different configuration parameter comprises at least one of a periodicity, an offset, a duration, an aggregation level, an associated corset, a monitoring symbol within a slot, a search space type, and at least one associated downlink control information format.

25-28. (canceled)

29. The method of claim 22, wherein the at least one condition comprises (i) a parameter for one or more timers associated with the at least one discontinuous reception state, (ii) a prior triggering command for a switch, and (iii) a type of discontinuous reception cycle corresponding to an on-duration timer that signifies to switch to the second of the at least two search space set groups.

30-40. (canceled)
